(19) United States
(12) Patent Application Publication
(10) Pub. No.: US 2016/0120738 A1
(43) Pub. Date: May 5, 2016

(54) SYSTEMS AND METHODS FOR MECHANICAL BONE GROWTH STIMULATION

(71) Applicant: Martin H. Pham, Los Angeles, CA (US)

(72) Inventor: Martin H. Pham, Los Angeles, CA (US)

(21) Appl. No.: 14/925,359

(22) Filed: Oct. 28, 2015

Related U.S. Application Data
(60) Provisional application No. 62/074,579, filed on Nov. 3, 2014.

(51) Int. Cl. A61H 23/02

(52) U.S. Cl. CPC A61H 23/02; A61H 2201/50; A61H 2205/08

(57) ABSTRACT

Systems and methods for mechanical bone growth to aid in promoting and accelerating bone growth are disclosed. In one implementation, a system may include a control unit, a mechanical bone growth stimulator with one or more stimulating mechanical discs configured to convert electrical energy into mechanical energy, and an electrical wire to electrically couple the control unit with one or more mechanical bone growth stimulators. The mechanical bone growth stimulator may provide various mechanical stimulations to a fractured or injured bone to decrease the time needed to heal or fuse the bone together.

### CROSS-REFERENCE TO RELATED APPLICATIONS

This application claims the benefit of and priority to U.S. Provisional Patent Application Ser. No. 62/074,579 filed on Nov. 3, 2014.

### TECHNICAL FIELD

The disclosed technology relates generally to bone growth or osteogenesis stimulation. More specifically, the present invention relates to systems and methods for mechanical bone growth stimulation.

### BACKGROUND

The human bone is living tissue that has the inherent ability to heal itself when injured or broken. However, the bone's natural healing process often takes a long time and can take a few months or even up to one year for new bone to properly form and fill the fractured area.

With any bone fracture or injury, there is always risk that the bone's healing process may be significantly delayed or even fail to properly heal and fuse together, otherwise known as a non-fusion, failed fusion, or pseudoarthrosis. Ensuring proper healing of a fractured or injured bone is a complicated metabolic process that requires the interaction of many biological factors, such as the availability of reparative cells. However, one of the most common reasons a fractured or injured bone may fail to fuse or properly heal altogether occurs when there is a prolonged or delayed union of a fractured bone.

Furthermore, ensuring proper and timely healing of an injured bone is crucial for the success of any type of surgery that proposes to surgically join two or more bones together, such as, by way of example only, a spinal fusion operation.

### BRIEF SUMMARY OF EMBODIMENTS

In light of the above-described problems associated with delayed and failed bone fusions, there is a need for bone growth stimulators to aide in promoting and accelerating proper bone growth.

Embodiments of the disclosed technology are directed towards a mechanical bone growth stimulation system to stimulate osteogenesis, or bone growth, by transmitting mechanical stimulation directly or adjacent to the bone via a disc that converts an electrical energy into a mechanical energy. As disclosed herein, the mechanical bone growth stimulation system need not be limited to placement of the disc near the bone to promote bone growth, but rather, may also be utilized to provide mechanical stimulation to other specified areas of interest, such as the muscle, cartilage, tendon, or ligament by way of example only.

In some embodiments, a mechanical bone growth stimulator is provided. The mechanical bone growth stimulator includes at least one stimulating mechanical disc configured to provide a mechanical stimulation to a target area in a patient's body, and an electrical wire coupled to the at least one stimulating mechanical disc to deliver an electrical energy thereto.

In some embodiments, a method for implanting a mechanical bone growth stimulator is provided. The method includes selecting a target incision site within a patient's body, and implanting a mechanical bone growth stimulator within the target incision site, the mechanical bone growth stimulator including at least one stimulating mechanical disc for providing a mechanical stimulation to a target area in the target incision site.

In some embodiments, a mechanical bone growth stimulation system is provided. The mechanical bone growth stimulation system includes a mechanical bone growth stimulator with a contact body with at least one stimulating mechanical disc embedded in the contact body and configured to convert an electrical energy to a mechanical stimulation applied to a target area of a patient, a control unit configured to provide the electrical energy to the at least one stimulating mechanical disc, and an electrical wire with a first end configured to be connected to the control unit and a second end attached to the at least one stimulating mechanical disc.

In some embodiments, the mechanical bone growth stimulator may include a contact body made of an inert flexible plastic material that is safe for attaching directly onto the human skin or implanting within a surgical incision site. In further embodiments, the mechanical bone growth stimulation system may include one or more stimulating mechanical discs embedded onto the mechanical bone growth stimulator to deliver mechanical stimulation to a specified area on the user. The mechanical bone growth stimulator may be attached to an electrical wire configured to generate an electrical connection between the mechanical bone growth stimulator and the control unit. Byway of example, the electrical wire may be covered with a flexible insulated material allowing the electrical wire to be bent and angled in various positions.

In some embodiments, a control unit includes an energy storage device configured to provide electrical power to the mechanical bone growth stimulation system. In accordance with yet another embodiment, the energy storage device may provide power to the electronic power controller to enable a user to select the degree of magnitude or frequency of mechanical bone growth stimulation applied to a user or patient via stimulating mechanical discs.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a diagram depicting a front view of an exemplary control unit of a mechanical bone growth stimulation system according to certain aspects of the present disclosure.

FIG. 2 is a diagram depicting a rear view of an exemplary control unit of a mechanical bone growth stimulation system according to certain embodiments of the present disclosure.

FIG. 3 is a diagram depicting certain functional blocks, components, and/or modules inside an exemplary control unit of a mechanical bone growth stimulation system according to certain embodiments of the present disclosure.

FIG. 4A is a figure depicting an exemplary mechanical bone growth stimulator according certain embodiments of the present disclosure.

FIG. 4B is a figure depicting another exemplary mechanical bone growth stimulator according to certain embodiments of the present disclosure.

FIG. 4C is a figure depicting another exemplary mechanical bone growth stimulator according to certain embodiments of the present disclosure.

FIG. 5 is a diagram illustrating an exemplary mechanical bone growth stimulation system according to certain aspects of the present disclosure.

FIG. 6 is a diagram illustrating an exemplary mechanical bone growth stimulation system with a set of mechanical bone growth stimulators implanted along the spine of a patient according to certain aspects of the present disclosure.

FIG. 7 is a diagram illustrating another exemplary mechanical bone growth stimulation system with a set of mechanical growth stimulators implanted along the spine of a patient according to certain aspects of the present disclosure.

FIG. 8 is a flow chart illustrating an exemplary process for implanting a mechanical bone growth stimulator according to certain embodiments of the present disclosure.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

Some embodiments of the present disclosure provide a mechanical bone growth stimulation system. As disclosed herein, a mechanical bone growth stimulation system may include an assembly to integrate a mechanical bone growth stimulator with a control unit via electrical wirings to provide mechanical stimulation to a specified target area. By way of example only, the specified target area may include an area near a fractured or injured bone so that the applied mechanical stimulation promotes and accelerates bone growth. By way of another example, the mechanical bone growth stimulators may be applied to a specified target area containing other osteogenic, osteoinductive, or osteoconductive material such as, by way of example only, bone autograft, bone allograft, or other biologic or biochemical substances utilized to improve bone growth.

In other embodiments, the mechanical bone growth stimulator may be applied to a selected target area for a plurality of medical purposes other than promoting bone growth. By way of example only, the mechanical bone growth stimulators may provide mechanical stimulation to aid in the growth, repair, and pain relief in areas such as the cardiac muscle, skeletal muscle, smooth muscle, cartilage, tendon, and ligaments.

In some embodiments, one or more mechanical bone growth stimulators of the mechanical bone growth stimulation system may be inserted through a surgical incision site and implanted near or adjacent to a specified target area, such as a fractured or injured spine requiring bone growth or fusion. In other embodiments, one or more mechanical bone growth stimulators is attached or placed directly onto the exterior surface of the skin so that the mechanical bone growth stimulator is placed directly over or adjacent to a specified target area.

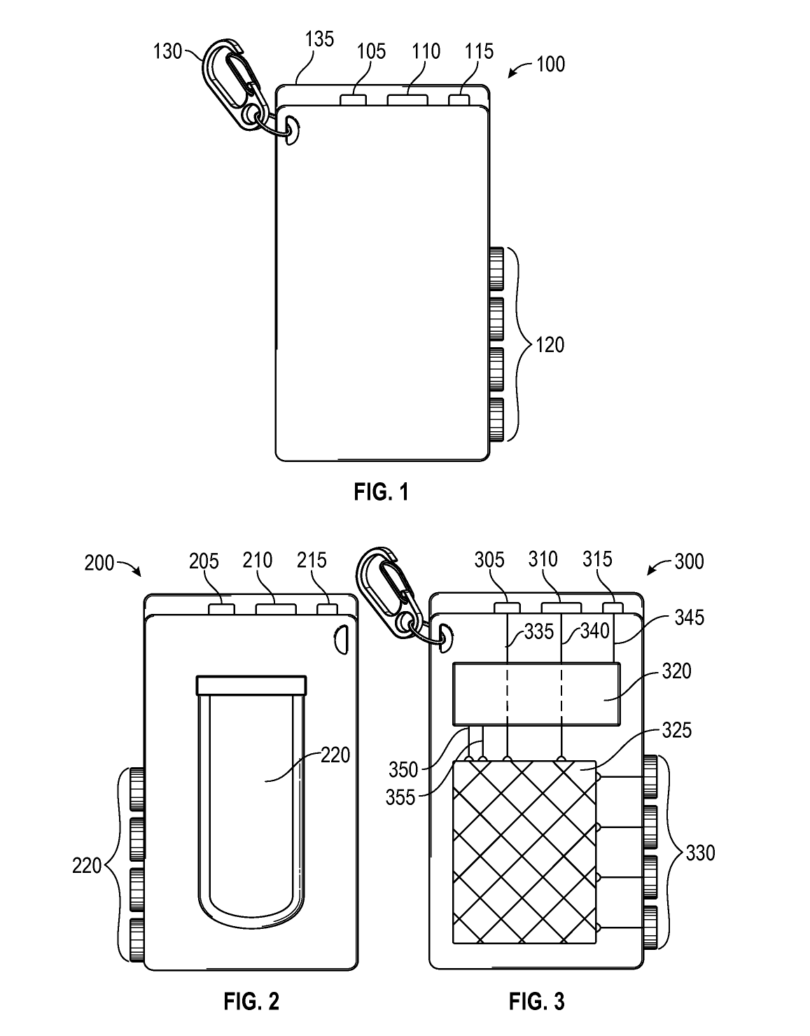

FIG. 1 is a diagram depicting a front view of an exemplary control unit 100 of a mechanical bone growth stimulation system according to certain aspects of the present disclosure. As illustrated, the control unit 100 includes a frequency selector switch 105 to modulate (e.g., select, set, adjust, change, alter, regulate, tune, and the like) the frequency of the mechanical stimulation applied a target area of a patient. The control unit 100 may further include a magnitude selector switch 110 to modulate the magnitude or strength of mechanical stimulation applied to a target area of a patient. The control unit 100 may be powered on or off via a power switch 115. However, it should be noted that the switches located on the control unit 100 are not merely limited to modulating the frequency or strength of the mechanical bone growth stimulator. Rather, the control unit 100 may include switches that modulate the various intensity, quality, or scale of mechanical stimulation based upon the type and character of mechanical stimulation applied to the user. For example, the types of mechanical stimulation may include, but are not limited to, vibration, pressure, or stretching. As such, the switches 105, 1110 and/or one or more additional switches (not shown) provided in the control unit 100 may adjust and regulate the mechanical stimulations according to the type applied to a user or patient.

The control unit 100 depicted in FIG. 1 further includes electrical ports 120 configured to electrically couple one or more mechanical bone growth stimulators to the control unit 100. In some embodiments, the control unit 100 may contain one or more electrical ports 120 so that one or more mechanical bone growth stimulators may be electrically coupled to the control unit 100 via one or more electrical wires.

The control unit 100 may also include fastening mechanisms to securely attach the control unit 100 onto a user or patient. In some embodiments, the control unit 100 may include a hooking mechanism 130 to securely clasp the control unit onto a user or patient. In some embodiments, the hooking mechanism 130 is a safety spring hook, trigger snap, or hook. In some embodiments, the control unit 100 may include a plastic cover 135 to protect the control unit 100 from the outside environment.

FIG. 2 is a diagram depicting a rear view of an exemplary control unit 200 of a mechanical bone growth stimulation system as described above with respect to FIG. 1. As illustrated, the control unit 200 includes switches 210, 215 for modulating (e.g., selecting or adjusting) the frequency and strength of mechanical stimulation applied to the user or patient. For example, the control unit 200 may include a frequency selector switch 215 to regulate, by way of example only, the frequency of mechanical vibrations transmitted to the mechanical bone growth stimulator (not shown here but discussed in detail below) from the control unit 200. The control unit 200 may also include a magnitude selector switch 210 to regulate, by way of example only, the magnitude of mechanical vibrations transmitted to the mechanical bone growth stimulator from the control unit 200.

In some embodiments, the control unit 200 may include a clip 220 to attach the control unit 200 to a user's clothing or personal belonging. The clip 220 may include a belt clip or joining clip.

FIG. 3 is a diagram depicting certain functional blocks, components, and/or modules inside an exemplary control unit 300 of a mechanical bone growth stimulation system according to certain embodiments of the present disclosure. As illustrated, the control unit 300 includes an energy storage device 320 for providing electrical power to an electronic power controller 325 via electronic wires 350, 355. Electric wire 350 electrically couples to the electronic power controller 325 by connecting to the positive terminal of the energy storage device 320. Electric wire 355 electrically couples the electronic power controller 325 by connecting to the negative terminal of the energy storage device 320. In some embodiments, the electronic power controller 325 provides a controlled electrical energy to one or more mechanical bone growth stimulators (not shown here but discussed in detail below) electrically coupled to the control unit 300 via electrical wires connected to electrical ports 330.

As further illustrated, the control unit 300 also includes a frequency selector switch 305 and a magnitude selector switch 310 electrically coupled to the electronic power controller 325 via electric wires 335, 340 respectively. The functions of the frequency and magnitude selector switches 305, 310 are substantially similar to the switches 105, 110 described above with respect to FIG. 1 and are not repeated here for the sake of brevity.

In some embodiments, the electronic power controller 325 may receive inputs or directions from the magnitude selector switch 310 and frequency selector switch 305 so that the magnitude and frequency of the mechanical stimulation (e.g., vibration, pressure, or stretching) may be modulated (e.g., selected or adjusted) accordingly. The electronic power controller 325 draws electrical power from the energy storage device 320 and provides a controlled electrical energy having, for example, a selected frequency and/or a selected magnitude to one or more stimulating mechanical discs (not shown here but discussed in detail below), where the one or more stimulating mechanical discs convert the electrical energy into a mechanical energy in the form of a mechanical stimulation (e.g., vibration, pressure, or stretching).

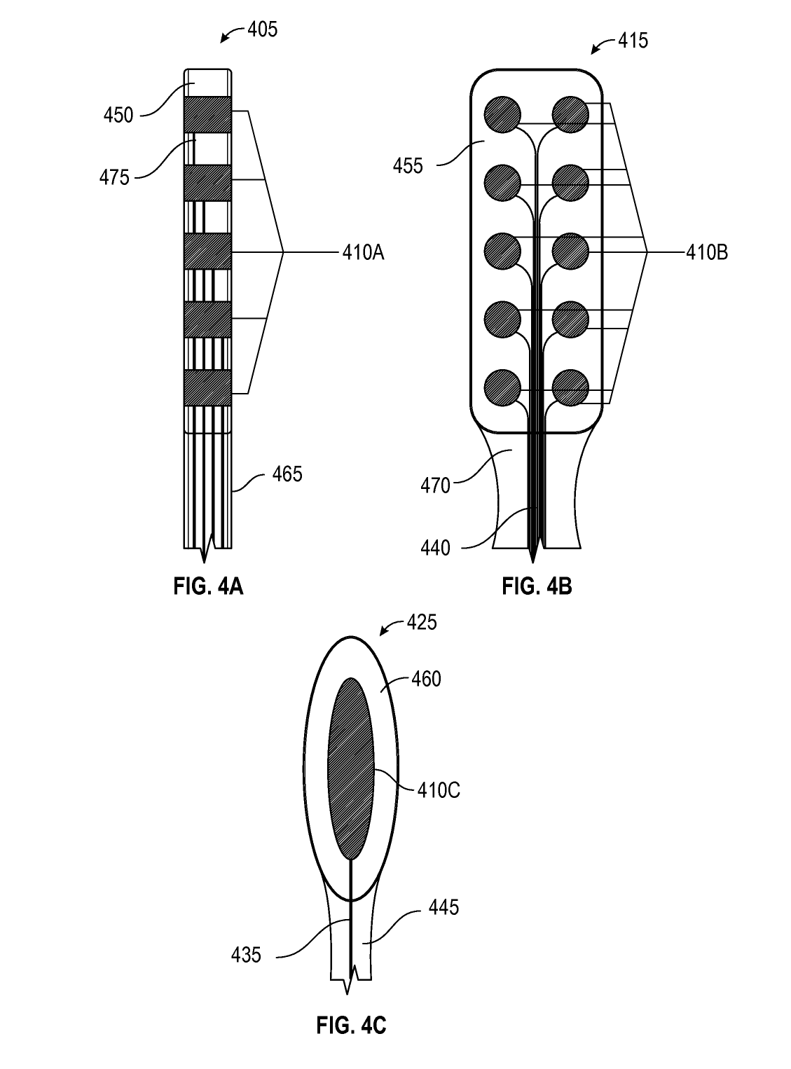

FIGS. 4A-4C are figures depicting exemplary mechanical bone growth stimulators 405, 415, 425 according to various embodiments of the present disclosure. FIG. 4A is a figure depicting an exemplary mechanical bone growth stimulator 405 according to one embodiment. As illustrated, the mechanical bone growth stimulator 405 includes a set of stimulating mechanical discs 410A that deliver the mechanical stimulation to a specified target area, such as a fractured or healing bone, of a patient in response to a controlled electrical energy received from a control unit (e.g., the control units 100, 200, 300 described above with respect to FIGS. 1, 2, and 3) via electrical wires 475. The electrical wires 475 are each electrically connected to stimulating mechanical discs 410A so that controlled electrical energy having one or more modulated electrical characteristics (e.g., selected magnitude and/or frequency) from the control unit (not shown) is provided to the stimulating mechanical discs 410A. In some embodiments, the electrical wires 475 may be covered with a wire sleeve 465 to protect the electrical wires 475 from the outside environment. The wire sleeve 465 may be made of a flexible insulated material allowing the electrical wire 475 to be bent and angled in various positions.

The mechanical bone growth stimulator 405 may come in varied shapes and sizes to accommodate various medical purposes. For example, FIG. 4A is an exemplary figure depicting a contact body 450 in the shape of a cylinder with one or more stimulating mechanical discs 410A embedded into the contact body 450 that makes a contact with a patient's body. In some embodiments, the contact body 450 may be made of an inert flexible plastic material that is safe for inserting into or attaching onto the human body. By way of example only, the cylindrical design may be optimal for implanting within a surgical bed aligned next to the spine so that the stimulating mechanical discs 410A provide a mechanical stimulation such as a stimulating vibration to aid in healing and reducing the time needed to develop sound bone growth and fusion.

FIG. 4B is a figure depicting another exemplary mechanical bone growth stimulator 405 according to another embodiment of FIG. 4A. Instead of a cylindrical design, the contact body 455 of the mechanical bone growth stimulator 415 may include a rectangular design. In the illustrated example, the mechanical bone growth stimulator 415 may be attached to an electrical wire 440 with a plurality of stimulating mechanical discs 410B arranged in a two-dimensional pattern and embedded onto the contact body 455 of the mechanical bone growth stimulator 415. The electrical wires 440 may be covered with a wire sleeve 470.

FIG. 4C is figure depicting another exemplary mechanical bone growth stimulator 425 according to another embodiment of FIG. 4A. Instead of a cylindrical design or a rectangular design, the contact body 460 of the mechanical bone growth stimulator 425 may include an oval design. In the illustrated example, the mechanical bone growth stimulator 425 may be attached to an electrical wire 435 with a single stimulating mechanical disc 410C embedded in the contact body 460. In the illustrated example, the disc 410C is substantially concentric with respect to the contact body 460. In other embodiments, two or more stimulating mechanical discs 410C (not shown) may be embedded into the contact body 460 of the mechanical bone growth stimulator 425. The electrical wire 435 may be covered with a wire sleeve 445. It should be noted that the contact body 450, 455, and 460 need not be limited to a cylindrical, rectangular, or oval shape, but rather, may also include a wide variety of shapes, such as a circle, square, triangle, or diamond to name a few by way of example only. It should also be noted that the stimulating mechanical discs 410A, 410B, 410C need not be limited to a rectangular, circular, or oval shape, but, may also include a wide variety of shapes, such as a square, triangle, or diamond to name a few by way of example only.

In some embodiments, the mechanical bone growth stimulators 405, 415, 425 discussed above may be surgically implanted within an incision site in a soft pocket of tissue near the target area selected to receive the mechanical stimulation. In some embodiments, the mechanical bone growth stimulators 405, 415, 425 may be directly attached onto the exterior surface of the skin near the target area selected to receive the mechanical stimulation, thus eliminating the need for surgical incisions.

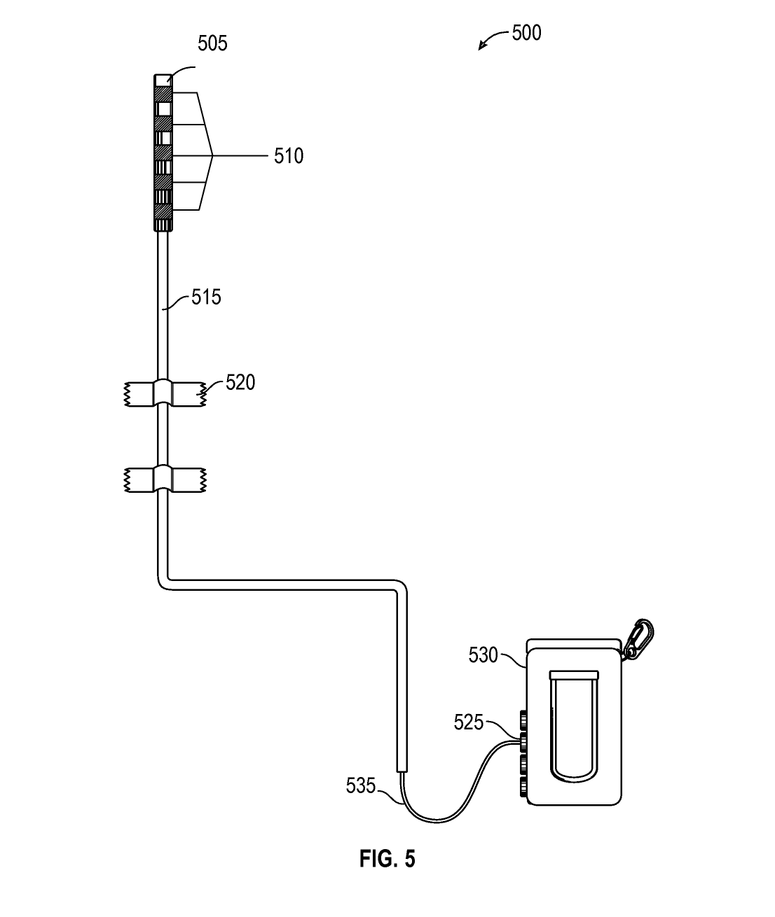

FIG. 5 is a diagram illustrating an exemplary mechanical bone growth stimulation system 500 according to certain aspects of the present disclosure. The exemplary figure depicts an exemplary mechanical bone growth stimulation system 500 where a set of stimulating mechanical discs 510 provides a mechanical stimulation (e.g., vibration, pressure, and stretching) to a specified area by converting electrical energy received from by the control unit 530 into a mechanical energy via the stimulating mechanical discs 510.

In the illustrated example, one mechanical bone growth stimulator 505 is connected to the control unit 530 via an electrical wire 535. As used herein, the electrical wire 535 can include two or more electrical connections for providing a DC or AC electrical voltage and/or current from the control unit to a mechanical bone growth stimulator or, more specifically, to one or more stimulating mechanical discs 510 embedded therein. The electrical wire 535 may be electronically coupled to an electrical port 525 to transmit electrical energy in the form of a DC or AC voltage/current from the control unit 530 to the discs 510 embedded in the mechanical bone growth stimulator 505. In some embodiments, the electrical wire 515 may be covered with a wire sleeve 515 made of a flexible insulated material so that the electrical wire 535 may be oriented in various positions and angles. In some embodiments, an adhesive material 520 may be utilized to securely attach the electrical wire 515 onto the user or patient.

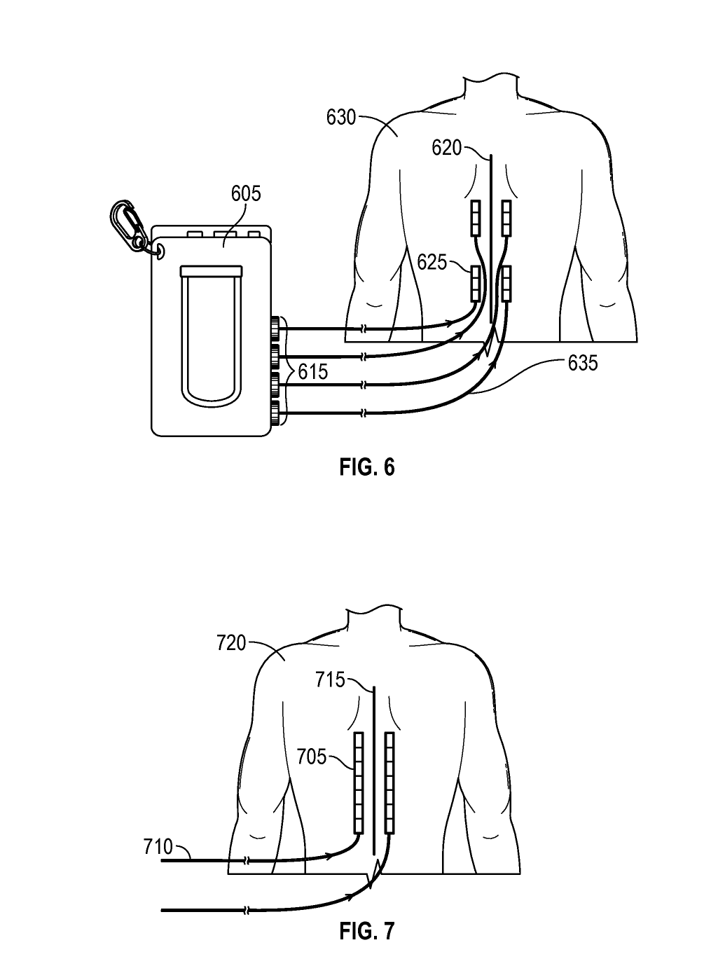

FIG. 6 is a diagram illustrating an exemplary mechanical bone growth stimulation system 600 with a set of mechanical bone growth stimulators 625 implanted along the spine 620 of the patient 630 according to certain aspects of the present disclosure. For example, one or more mechanical bone growth stimulators 625 may be connected to a control unit 605 via electrical wires 635 electrically coupled to one or more electrical ports 615.

In some embodiments, the multiple mechanical bone growth stimulators 625 may be placed on a patient's backside 630, such as the spine 620 after a spinal fusion procedure. In other embodiments, one or more mechanical bone growth stimulators 625 may be placed in other various target areas of the body requiring mechanical stimulation, such as the arms, legs, neck, and so forth.

FIG. 7 is a diagram illustrating another exemplary mechanical bone growth stimulation system 700 with a set of mechanical bone growth stimulators 705 implanted along the spine 715 of a patient 720 according to certain aspects of the present disclosure. The mechanical bone growth stimulators 705 may be connected to an electrical wire allowing the mechanical bone growth stimulator 705 to be electrically coupled to the control unit.

According to one embodiment, the one or more mechanical bone growth stimulators 705 attached to a patient 720 may include a mechanical bone growth stimulator 705 shaped in the form of an elongated cylinder. Instead of multiple shorter mechanical simulators as depicted in FIG. 6, the elongated cylinder shape of the mechanical bone growth stimulators 705 may be ideal for placement along each side of a bone requiring extensive or multiple bone fusions. In contrast, by way of example only, multiple shorter mechanical bone growth stimulators as depicted in FIG. 5, may be ideal for placement along smaller or concentrated target areas, such as areas with smaller bone fractures.

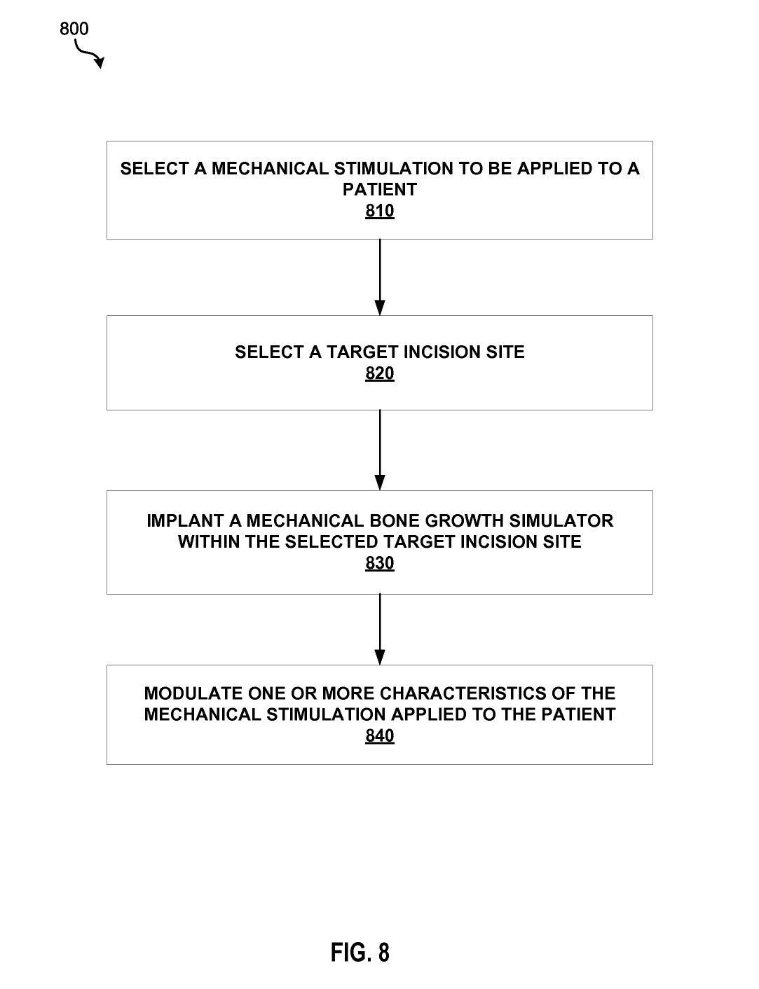

FIG. 8 is a flow chart illustrating an exemplary process for implanting a mechanical bone growth stimulator according to certain embodiments of the present disclosure. The exemplary process 800 begins at operation 810 by selecting a type of mechanical stimulation to be applied to the patient based on a specific medical requirement or need. By way of example only, the types of mechanical stimulations may include vibration, pressure, and stretching stimulations applied to areas such as the bone, cardiac muscle, skeletal muscle, smooth muscle, cartilage, tendon, and ligaments. After selecting the type of mechanical stimulation to be applied, exemplary process 800 proceeds to operation 820, where a target incision site is selected for implanting the mechanical bone growth stimulator. Once a surgical opening is created, the exemplary process proceeds to 830, where the mechanical bone growth stimulator is implanted within the surgical bed of the surgical incision site. The mechanical bone growth stimulator may be securely placed within the incision site such that the surgical opening is closed around the electrical wire connected to the implanted mechanical bone growth stimulator. Once the mechanical bone growth stimulator is properly implanted, the mechanical bone growth stimulator is ready to deliver the mechanical stimulation to the areas surrounding the implanted mechanical bone growth stimulator.

Exemplary process 800 further proceeds to operation 840 where the user (e.g., a doctor or patient) may modulate the one or more characteristics of the mechanical stimulation applied to the patient. By way of example, a patient or user may determine the appropriate frequency of mechanical stimulation to be applied to the target area by selecting or readjusting the switches that modulate the frequency of mechanical stimulation. By way of another example, a patient or user may determine the appropriate magnitude and strength of the mechanical stimulation to be applied to the target area by selecting or readjusting the switches that modulate the strength of mechanical stimulation.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A mechanical bone growth stimulator comprising:
at least one stimulating mechanical disc configured to provide a mechanical stimulation to a target area in a patient's body; and
an electrical wire coupled to the at least one stimulating mechanical disc and deliver an electrical energy thereto.

2. The mechanical bone growth stimulator of claim 1, wherein the at least one stimulating mechanical disc comprises a vibrating disc configured to generate a mechanical stimulation in response to the electrical energy.

3. The mechanical bone growth stimulator of claim 1, wherein the at least one stimulating mechanical disc comprises a pressure disc configured to generate a stimulating pressure in response to the electrical energy.

4. The mechanical bone growth stimulator of claim 1, wherein the at least one stimulating mechanical disc is embedded in a contact body that is configured to be in physical contact with the patient's body.

5. The mechanical bone growth stimulator of claim 4, wherein the contact body comprises an inert flexible plastic.

6. The mechanical bone growth stimulator of claim 5, wherein the inert flexible plastic is suitable for implanting within a surgical incision site.

7. The mechanical bone growth stimulator of claim 4, wherein the contact body is of a substantially cylindrical shape.

8. The mechanical bone growth stimulator of claim 7, wherein the at least one stimulating mechanical disc comprises a plurality of stimulating mechanical discs arranged along an axis of the contact body.

9. The mechanical bone growth stimulator of claim 4, wherein the contact body is of a substantially rectangular shape.

10. The mechanical bone growth stimulator of claim 9, wherein the at least one stimulating mechanical disc comprises a plurality of stimulating mechanical discs arranged in a two-dimensional pattern in the contact body.

11. The mechanical bone growth stimulator of claim 4, wherein the contact body is of an oval shape, and the at least one stimulating mechanical disc comprises of one stimulating mechanical disc that is of an oval shape and substantially concentric with respect to the contact body.

12. A method for implanting a mechanical bone growth stimulator comprising:
selecting a target incision site within a patient's body; and
implanting a mechanical bone growth stimulator within the target incision site, the mechanical bone growth stimulator comprising at least one stimulating mechanical disc for providing a mechanical stimulation to a target area in the target incision site.

13. The method of claim 12, wherein the at least one stimulating mechanical disc is configured to administer a stimulating pressure to the target area.

14. The method of claim 12, wherein the at least one stimulating mechanical disc is configured to administer a stimulating vibration to the target area.

15. The method of claim 12, wherein the at least one stimulating mechanical disc is configured to administer a stimulating stretch to the target area.

16. The method of claim 12 further comprising selecting an appropriate degree of mechanical stimulation applied to the target area.

17. The method of claim 16, wherein the target incision site comprises an area near a spine.

18. The method of claim 16, wherein selecting the appropriate degree of the mechanical stimulation comprises selecting a frequency of the mechanical stimulation applied to the target area.

19. The method of claim 16, wherein selecting the appropriate degree of the mechanical stimulation comprises selecting a strength of the mechanical stimulation applied to the target area.

20. A mechanical bone growth stimulation system comprising:
a mechanical bone growth stimulator comprising a contact body with at least one stimulating mechanical disc embedded in the contact body and configured to convert an electrical energy to a mechanical stimulation applied to a target area of a patient;
a control unit configured to provide the electrical energy to the at least one stimulating mechanical disc; and
an electrical wire with a first end configured to be connected to the control unit and a second end attached to the at least one stimulating mechanical disc.

21. The mechanical bone growth stimulation system of claim 20, wherein the control unit comprises an electrical port configured to receive the first end of the electrical wire.

22. The mechanical bone growth stimulation system of claim 20, wherein the control unit comprises a mechanical selector switch configured to modulate a strength of the mechanical stimulation applied to the target area.

23. The mechanical bone growth stimulation system of claim 20, wherein the control unit comprises a frequency selector switch configured to modulate a frequency of the mechanical stimulation applied to the target area.
